(19) United States
(12) Patent Application Publication
(10) Pub. No.: US 2002/0174534 A1
(43) Pub. Date: Nov. 28, 2002

(54) Electric connection box

(75) Inventors: Masakazu Murakami, Hikone-shi (JP); Shin Hasegawa, Hikone-shi (JP); Tatsuo Satori, Hikone-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/191,429

(22) Filed: Jul. 10, 2002

Related U.S. Application Data
(62) Division of application No. 09/593,005, filed on Jun. 13, 2000.

(30) Foreign Application Priority Data
Jun. 17, 1999 (JP) 11-171066

(51) Int. Cl. H01F 7/06; H01F 27/02

(52) U.S. Cl. 29/606; 29/605; 336/90

(57) ABSTRACT

Disclosed are a method of manufacturing a wiring member, and an electric connection box manufactured by retaining the manufactured wiring member in a case. The method comprises the steps of winding an electric wire around a wire winding body having a plurality of wire holding members arranged thereon, and wiring the electric wire into a desired pattern using a plurality of retaining sections formed on each of the wire holding members; cutting the electric wire at a desired position; and removing the electric wire at least from the wire winding body.

### BACKGROUND OF THE INVENTION

1. Field of the Invention

The present invention relates to a method of manufacturing a wiring member and an electric connection box which uses a wiring member manufactured by this method.

2. Description of the Related Art

In an electric connection box, an electric wire is wired, one at a time, on a wiring plate, which is formed of an electrically insulating synthetic resin and has a plurality of projections between which an electric wire is laid out, and is cut and those works are repeated to form a wiring member having a circuit of a desired pattern. For example, Japanese Unexamined Patent Publication (KOKAI) No. Hei 8-79943 discloses a wiring method for a wiring member assembly, which places a wiring member, acquired in the above-described manner, on a wiring board having a bus bar, and pressing the electric wire in slots of pressure-contacting terminals provided on the bus bar by a pressing jig, thereby forming an internal circuit of an electric connection box.

The wiring member assembly disclosed in the publication is acquired by repeating the works of wiring an electric wire on a wiring member one at a time and cutting the electric wire as in the above-described wiring-member acquisition. The wiring work for a wiring member assembly takes time and thus manufacturing the wiring member assembly also takes time. Accordingly, the manufacture of an electric connection box takes time, desadvantageously.

As an electric wire is wired one at a time to form a circuit of a desired pattern, the wiring head of a wiring machine which holds the electric wire should be designed to be movable three-dimensionally in order to cope with complicated circuit patterns. The wiring machine inevitably has a complex structure and becomes expensive, which makes a wiring member assembly and thus an electric connection box expensive.

Further, as the structure of the wiring machine becomes complex, a wiring program for wiring electric wires become elaborate. What is more, a wiring plate is a special component whose outer shape matches with each type of electric connection box. Those factors make it difficult to cope with a change in the design of a circuit in an electric connection box.

### SUMMARY OF THE INVENTION

Accordingly, it is an object of the present invention to provide a method of manufacturing a wiring member and an electric connection box, which allow a wiring member to be manufactured in a short period of time using a wiring machine with a simple structure without using a special wiring plate and which can easily cope with a change in circuit design.

To achieve the above object, a method of manufacturing a wiring member according to this invention comprises the steps of winding an electric wire around a wire winding body having a plurality of wire holding members arranged thereon, and wiring the electric wire into a desired pattern using a plurality of retaining sections formed on each of the wire holding members; cutting the electric wire at a desired position; and removing the electric wire at least from the wire winding body.

It is preferable that a rotary shaft and a plurality of inserting sections where the wire holding members are inserted should be formed on the wire winding body.

It is preferable that the retaining sections be retaining grooves.

It is further preferable that each of the wire holding member should have a terminal groove formed in a direction perpendicular to a layout direction of the plurality of retaining grooves.

To achieve the object of this invention, an electric connection box according to this invention is manufactured by retaining a wiring member manufactured by the above-described method recited in a case.

It is preferable that the case should have an upper case and a lower case.

According to the present invention, there are provided a method of manufacturing a wiring member and an electric connection box, which allow a wiring member to be manufactured in a short period of time using a wiring machine with a simple structure without using a special wiring plate and which can easily cope with a change in circuit design.

The aforementioned object of this invention, together with other objects, features and advantages thereof, will be readily apparent from the following description with reference to the accompanying drawings.

### BRIEF DESCRIPTION OF THE DRAWINGS

FIG. 1 is a perspective view illustrating the schematic structure of a wiring machine to which a method of manufacturing a wiring member according to this invention is adapted;

FIG. 2 is a perspective view showing a step of wiring an electric wire into a desired pattern using the wiring machine in FIG. 1;

FIG. 3 is a perspective view showing a step of cutting the electric wire, wired into the desired pattern, at a desired position using the wiring machine in FIG. 1;

FIG. 4 is a perspective view of a wiring member which is manufactured through a step of cutting the electric wire at a desired position and removing the electric wire from a wire winding body;

FIG. 5 is a perspective view depicting a step of installing the wiring member in FIG. 4 into the upper case of an electric connection box;

FIG. 6 is a perspective view showing the wiring member in FIG. 4 installed into the upper case of the electric connection box;

FIG. 7 is an enlarged perspective view of essential portions illustrating another mode of installing the wiring member in FIG. 4 into the upper case of an electric connection box;

FIG. 8 is a perspective view showing how to construct an electric connection box of this invention by fitting a lower case into the upper case shown in FIG. 6 in which the wiring member has been installed;

FIG. 9 is a perspective view depicting a modification of a wire holding member of a wiring member and the essential portion of the upper case shown in FIG. 5, which is used at the time of using the wire holding member;

FIG. 10 is a perspective view depicting how to install a wiring member, which uses the wire holding member shown in FIG. 9, into the upper case;

FIG. 11 is a perspective view illustrating a method of manufacturing a wiring member according to another embodiment of this invention and a wiring machine which uses another wire holding member;

FIG. 12 is a perspective view showing a step of wiring an electric wire into a desired pattern using the wiring machine in FIG. 11 and how to attach a cover on the wire holding member after wiring;

FIG. 13 is a perspective view showing how to attach a wiring member, acquired by cutting the electric wire into a desired pattern, at a desired position and removing the electric wire from a wire winding body, to a bus-bar wiring member;

FIG. 14 is a perspective view depicting the wiring member in FIG. 13 attached to the bus-bar wiring member;

FIG. 15 is a perspective view illustrating a method of manufacturing a wiring member according to a further embodiment of this invention and a plurality of wire holding members attached to an insulating sheet;

FIG. 16 is a perspective view showing how to secure the insulating sheet shown in FIG. 15 on a wiring machine;

FIG. 17 is a perspective view showing an electric wire wired into a desired pattern and cut at a desired position by using the wiring machine on which the insulating sheet shown in FIG. 15 is secured;

FIG. 18 is a perspective view showing how to attach a wiring member, acquired by removing the insulating sheet shown in FIG. 17 from the wiring machine, to a bus-bar wiring member;

FIG. 19 is a perspective view depicting the wiring member shown in FIG. 18 attached to the bus-bar wiring member;

FIG. 20 is a perspective view illustrating how to construct an electric connection box of this invention by installing the wiring-member-attached bus-bar wiring member shown in FIG. 19 in the upper case and lower case;

FIG. 21 is a perspective view illustrating a method of manufacturing a wiring member according to a still further embodiment of this invention and a wiring machine on which a plurality of wire holding members are attached;

FIG. 22 is a perspective view showing how to secure an insulating sheet having openings formed at positions corresponding to a plurality of wire holding members on the wiring machine in FIG. 21;

FIGS. 23A through 23C are perspective views depicting a plurality of steps of stacking insulating sheets and wiring an electric wire into a desired pattern;

FIG. 24 is a perspective view showing wired electric wires removed together with the insulating sheets from the wiring machine;

FIG. 25 is a perspective view illustrating a method of manufacturing a wiring member according to a still yet further embodiment of this invention and a wiring machine for manufacturing a plurality of wiring members simultaneously;

FIG. 26 is a perspective view illustrating the schematic structure of another wiring machine to which the method of manufacturing a wiring member according to this invention is adapted;

FIG. 27 is a perspective view showing a step of wiring an electric wire into a desired pattern using the wiring machine in FIG. 26;

FIG. 28 is a perspective view showing a step of cutting the electric wire, wired into the desired pattern, at a desired position using the wiring machine in FIG. 26;

FIG. 29 is a perspective view showing the precursor of a wiring member which is manufactured through a step of cutting the electric wire at a desired position and removing the electric wire from a wire winding body;

FIG. 30 is a perspective view showing how to attach the precursor of a wiring member to a bus-bar wiring member via an insulating plate;

FIG. 31 is a perspective view showing the precursor of the wiring member attached to the bus-bar wiring member via the insulating plate;

FIG. 32 is a perspective view of a wiring member acquired by removing wire holding members from the bus-bar wiring member in FIG. 31;

FIG. 33 is a perspective view illustrating another method of manufacturing a wiring member using a wire holding plate; and

FIG. 34 is a perspective view showing how to attach the wire holding plate shown in FIG. 33 to a bus-bar wiring member via an insulating plate.

### DETAILED DESCRIPTION OF THE PREFERRED EMBODIMENTS

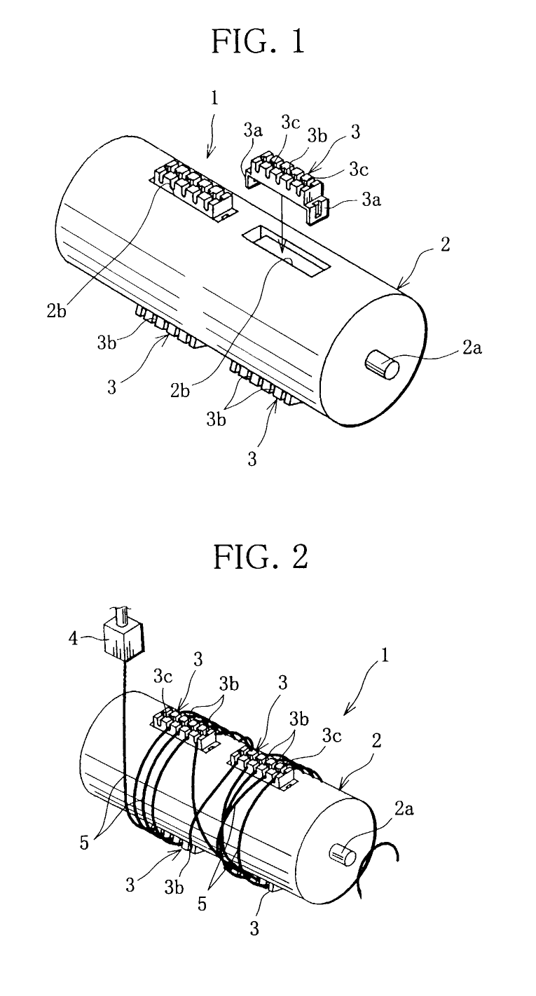

Preferred embodiments of a method of manufacturing a wiring member and an electric connection box according to the present invention will now be described referring to FIGS. 1 through 34.

First, a description will be given of a wiring machine which is used at the time of manufacturing a wiring member of this invention. A wiring machine 1 has a wire winding body 2 having a rotary shaft 2a and a plurality of inserting sections 2b formed therein where wire holding members 3 are respectively inserted. The wiring machine 1 also has a wiring head 4 (see FIG. 2) located above the wire winding body 2. The wiring head 4 wires an electric wire 5 to be discussed later in a one-stroke drawing style. The rotation of the wire winding body 2 and the operation of the wiring head 4, etc. are controlled by unillustrated control means.

The wire winding body 2 is rotated about the rotary shaft 2a in the direction of the arrow in FIG. 2 by unillustrated drive means. It is to be noted that the wire winding body 2 can rotate in the reverse direction at a desired position to wire the electric wire 5 in a U form depending on the circuit pattern.

Each wire holding member 3 has engagement pieces 3a respectively formed on both sides and a plurality of retaining grooves 3b formed widthwise, with a terminal groove 3c formed in the center and traversing the individual retaining grooves 3b.

The wiring head 4 is movable in the axial direction of the rotary shaft 2a. In accordance with the rotation of the wire winding body 2, the wiring head 4 draws out the electric wire 5 from an unillustrated drum and feeds it out to the wire winding body 2.

In manufacturing a wiring member, first, the wire holding members 3 are inserted in the respective inserting sections 2b of the wire winding body 2 and the electric wire 5 is fed out from the wiring head 4 while rotating the wire winding body 2 in the direction of the arrow as shown in FIG. 2. Accordingly, the wiring machine 1 winds the electric wire 5, fed out from the wiring head 4, around the wire winding body 2 in a one-stroke drawing style and wires the electric wire 5 into a desired pattern by retaining the electric wire using the retaining grooves 3b of each wire holding member 3 while moving the wiring head 4 in the axial direction of the rotary shaft 2a.

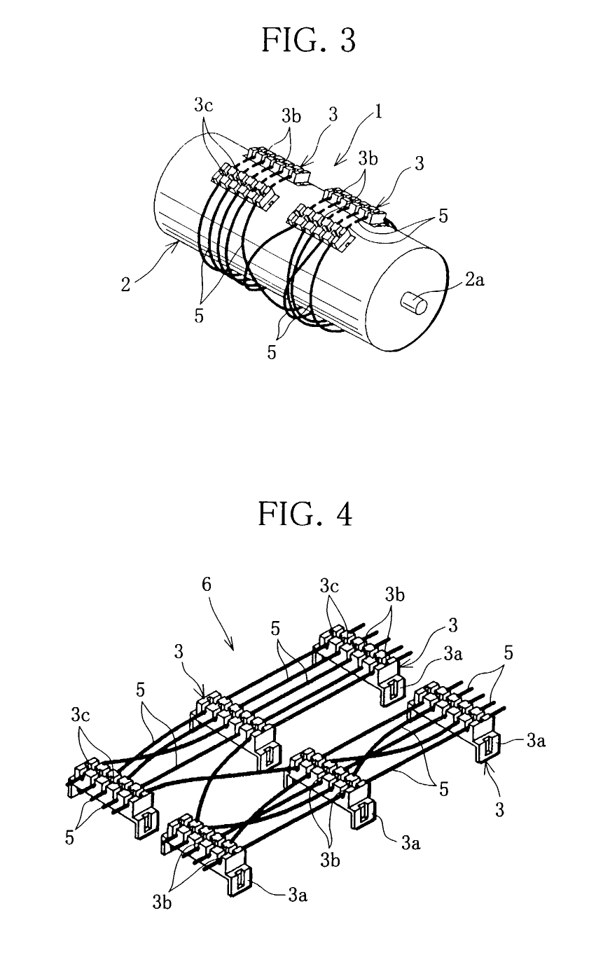

When wiring the electric wire 5 into a desired pattern by winding the electric wire 5 around the wire winding body 2 is completed, the electric wire 5 is cut at a desired position, e.g., in the vicinity of the wire holding members 3 as shown in FIG. 3.

Then, the electric wire 5 is removed together with the wire holding members 3 from the wire winding body 2, thus yielding a wiring member 6 shown in FIG. 4 which has the electric wire 5 wired into the desired pattern.

According to the method of this invention, as described above, the electric wire 5 is wound around the wire winding body 2 having a plurality of wire holding members 3 arranged thereon and the wiring head 4 is moved in the axial direction of the rotary shaft 2a. According to this method, after the electric wire 5 is retained in a plurality of retaining grooves 3b formed in each wire holding member 3 and wired into a desired pattern and is cut at a desired position, the electric wire 5 is removed together with the wire holding members 3 from the wire winding body 2, thus yielding the wiring member 6. This method can therefore manufacture the wiring member 6 in a short period of time by using the wiring machine 1 having a simple structure, without requiring any special wiring plate, and can easily cope with a change in circuit design.

The wiring member 6 manufactured in the above manner is installed in an electric connection box in the following manner.

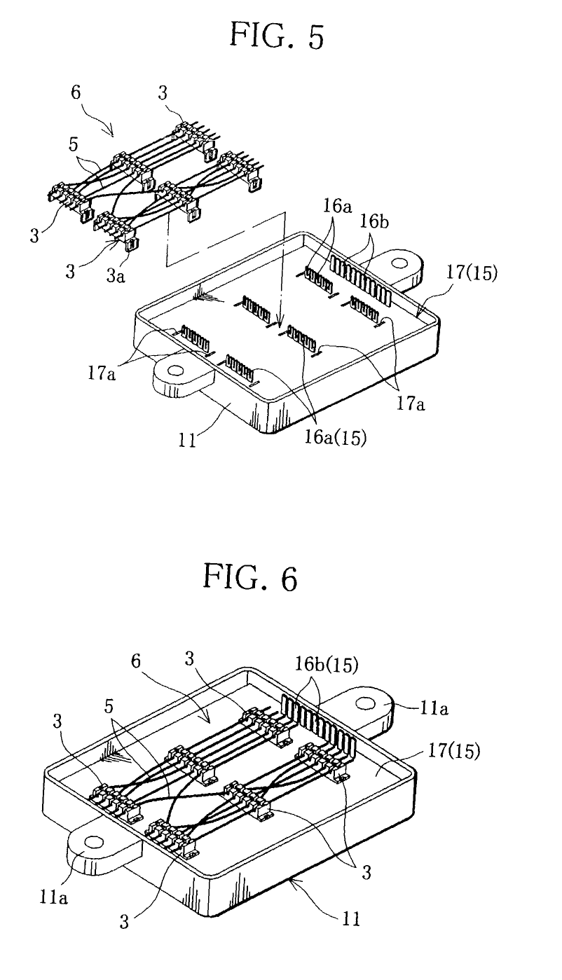

First, as shown in FIG. 5, the wiring member 6 is placed in an upper case 11 where a bus-bar wiring member 15 which has a plurality of bus bars 16 (not shown) and a plurality of insulating plates 17 stacked has been accommodated in advance. At this time, a plurality of pressure-contacting terminals 16a and tab terminals 16b of each bus bar 16 protrude from the associated insulating plate 17 at adequate positions, and the insulating plate 17 has inserting holes 17a formed in the vicinity of those pressure-contacting terminals 16a. The engagement pieces 3a of the wire holding members 3 are to be pressed in the respective inserting holes 17a. The upper case 11 is a flat box with attachment brackets 11a formed outside, and is to be fitted over a lower case 12 to be discussed later.

As the individual engagement pieces 3a of a plurality of wire holding members 3 are pressed into the respective inserting holes 17a and attached to the bus-bar wiring member 15, therefore, the individual pressure-contacting terminals 16a are fitted into the respective terminal grooves 3c of the wire holding members 3 so that the associated bus bars 16 are connected to the electric wires 5 and the wiring member 6 is retained in the upper case 11, as shown in FIG. 6.

At this time, the individual electric wires 5 are pressed one by one from above with a proper jig so as to be surely connected to the respective pressure-contacting terminals 16a. The individual electric wires 5 may be connected to the respective pressure-contacting terminals 16a by pressure-contacting or the like. As each wire holding member 3 is attached by pressing the individual engagement pieces 3a into the respective inserting holes 17a of the insulating plate 17, it can prevent the wiring member 6 from being improperly attached to the bus-bar wiring member 15 due to warping of the insulating plate 17 or other external force.

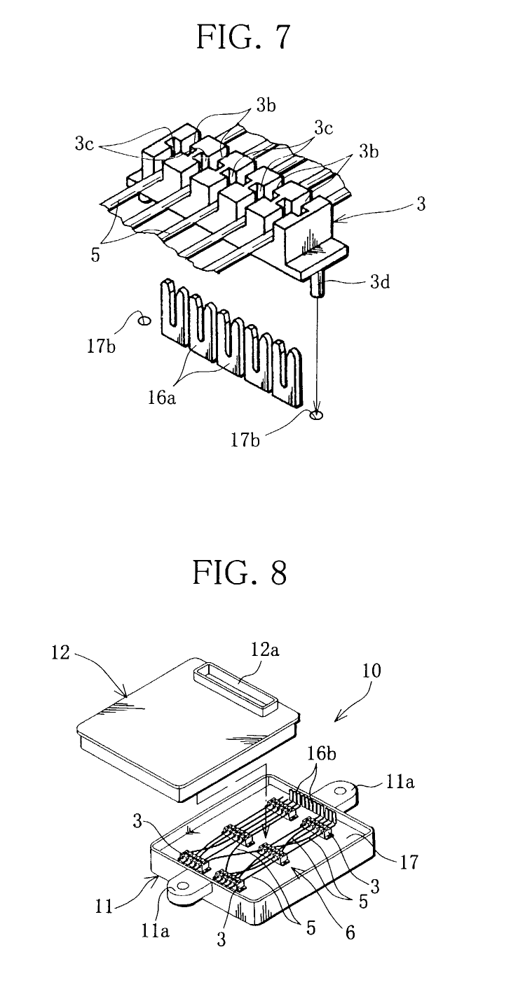

The engagement pieces 3a of the wire holding member 3 used in the wiring member 6 may be replaced with protruding bosses 3d which engage with engagement holes 17b formed in the insulating plate 17 as shown in FIG. 7.

Next, the lower case 12 is fitted into the upper case 11 retaining the wiring member 6, thus assembling an electric connection box 10 as shown in FIG. 8. The lower case 12 is a flat box and has a connector housing 12a formed at a position corresponding to a plurality of tab terminals 16b to retain those tab terminals 16b.

As the electric connection box 10 is constructed by placing the wiring member 6, which uses no special wiring plate and is manufactured in a short period of time using the wiring machine 1 having a simple structure, inside the upper case 11 and the lower case 12, the electric connection box 10 can easily be adapted to a change in circuit design, and can be manufactured at low cost.

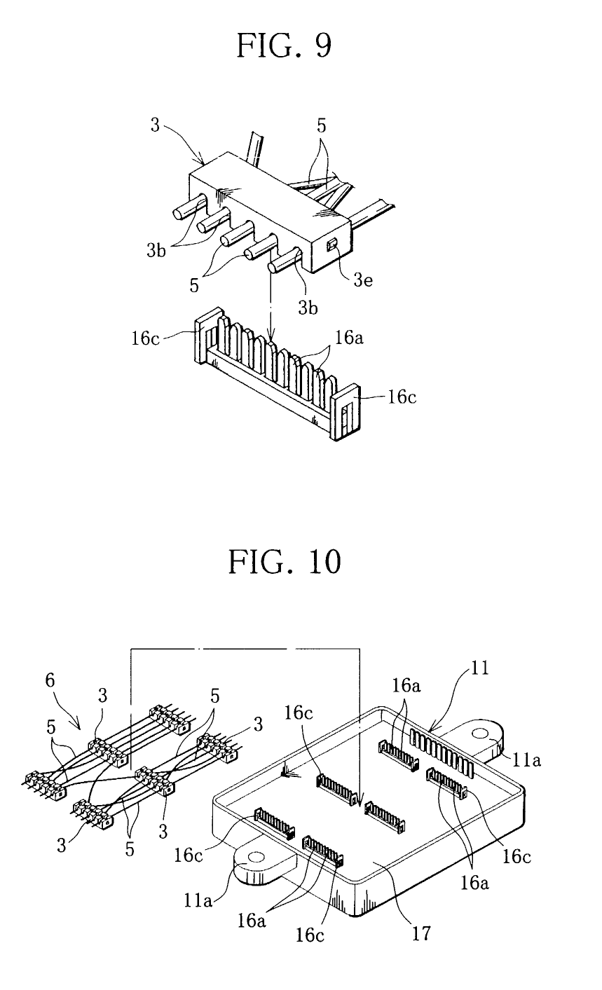

The engagement pieces 3a of the wire holding member 3 used in the wiring member 6 may be replaced with engagement projections 3e that engage with engagement pieces 16c which are formed on the bus bar 16 and protrude from the insulating plate 17 as shown in FIG. 9.

In this case, the wiring member 6 is engaged, in a turned-over state, with the engagement pieces 16c to be attached to the insulating plate 17, as shown in FIG. 10. As a result, the pressure-contacting terminals 16a of the bus bars 16 are fitted into the respective terminal grooves 3c of the wire holding members 3 of the wiring member 6 so that the associated bus bars 16 are connected at a time by the electric wires 5. This wiring member 6, unlike the wiring member 6 shown in FIG. 6, does not require that the individual electric wires 5 be pressed into the retaining grooves 3b one at a time using a proper jig.

The wire holding member 3 used in the wiring member 6 may be designed in such a way that in order to prevent the electric wires 5 from coming off the retaining grooves 3b before the wire holding member 3 is attached to the bus-bar wiring member 15, a cover 7 (see FIG. 12) is attached to the wire holding member 3 after the electric wire 5 is wired into a desired pattern.

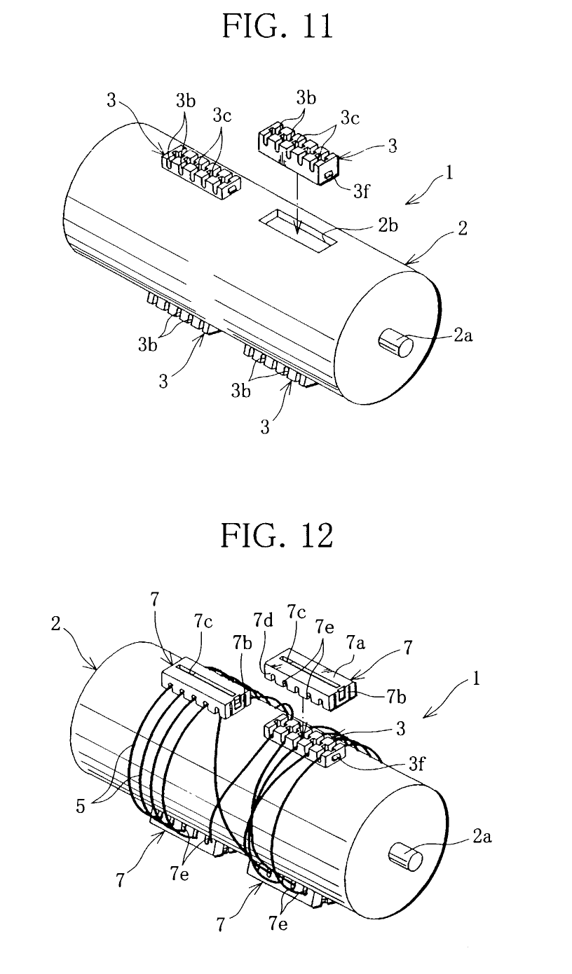

In this case, the wire holding member 3 is provided with engagement projections 3f to catch an engagement piece 7a (sic) (see FIG. 12) of the cover 7. Therefore, the wiring machine 1 forms a plurality of inserting sections 2b for insertion of the wire holding members 3 each in the shape that matches with the outline of the wire holding member 3 as shown in FIG. 11 As shown in FIG. 12, the cover 7 has engagement pieces 7b on both lengthwise sides of the body 7a and a slit 7c extending lengthwise. The cover 7 further has a plurality of recesses 7e formed in side walls 7d on both widthwise sides of the body 7a in association with the retaining grooves 3b.

As shown in FIG. 12, the wiring machine 1 winds the electric wire 5, fed out from the wiring head (not shown), around the wire winding body 2 in a one-stroke drawing style and moves the wiring head in the axial direction of the rotary shaft 2a to wire the electric wire 5 into a desired pattern by using the retaining grooves 3b of each wire holding member 3.

When wiring the electric wire 5 into a desired pattern by winding the electric wire 5 around the wire winding body 2 is completed, the cover 7 is attached to each wire holding member 3 as shown in FIG. 12, the electric wire 5 is cut at a desired position, e.g., in the vicinity of the wire holding members 3, and is removed from the wire winding body 2, thus yielding the wiring member 6.

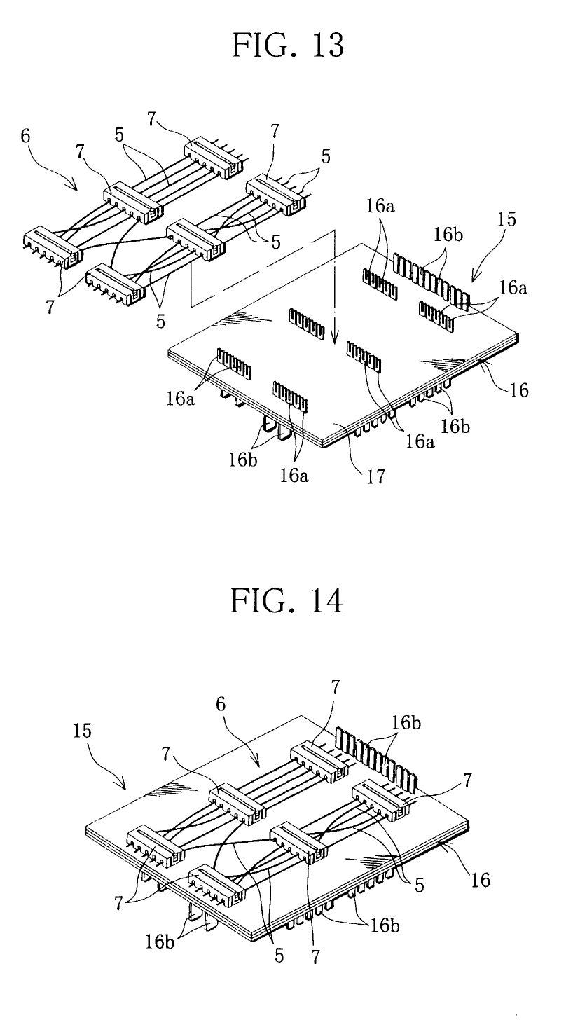

The wiring member 6 manufactured in this manner is attached to the bus-bar wiring member 15 at the respective pressure-contacting terminals 16a, as shown in FIG. 13. As a result, the individual pressure-contacting terminals 16a are fitted into the respective terminal grooves 3c of the wire holding members 3, causing the associated bus bars 16 to be connected together by the electric wires 5, so that the wiring member 6 is attached to the bus-bar wiring member 15, as shown in FIG. 14.

As the cover 7 is attached to each wire holding member 3 of the wiring member 6 at this time, the cover 7 prevents the electric wire 5 from lifting up and coming off the retaining groove 3b until the wiring member 6 is attached to the bus-bar wiring member 15. This facilitates the handling of the wiring member 6.

A description will now be given of another embodiment of the wiring-member manufacturing method of this invention which is designed to improve the working efficiency at the time of removing the wiring member from the wiring machine 1 and in consideration of preventing a contact between the bus bar and the electric wire.

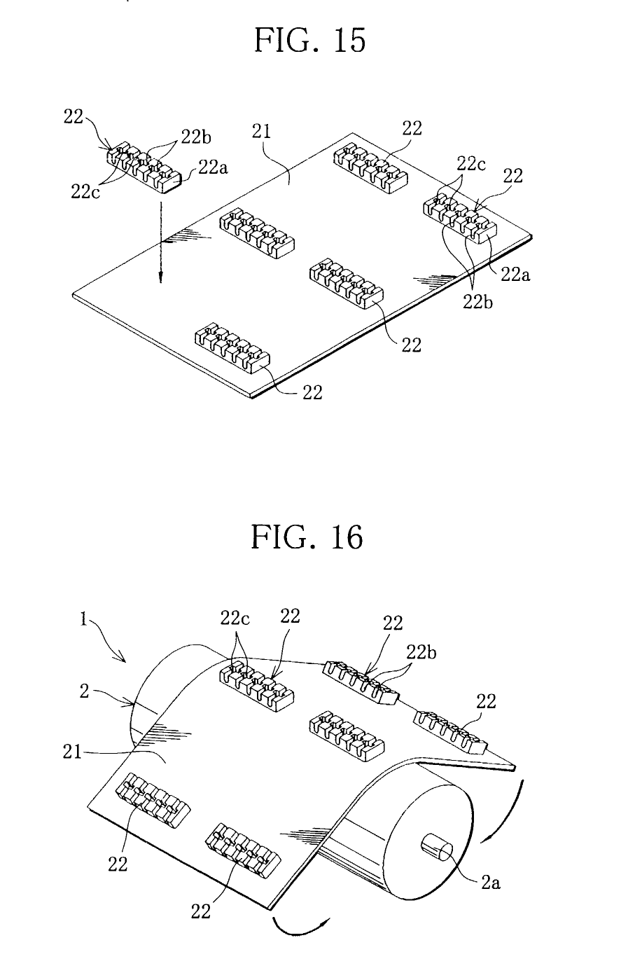

First, as shown in FIG. 15, wire holding members 22 are attached to an insulating sheet 21 of a synthetic resin having a flexibility, such as PET (Polyethylene terephthalate) or vinyl chloride. The wire holding member 22 is constructed in approximately the same way as the wire holding member 3, has a plurality of retaining grooves 22b formed widthwise in a body 22a and a terminal groove 22c formed in the center and traversing the individual retaining grooves 22b.

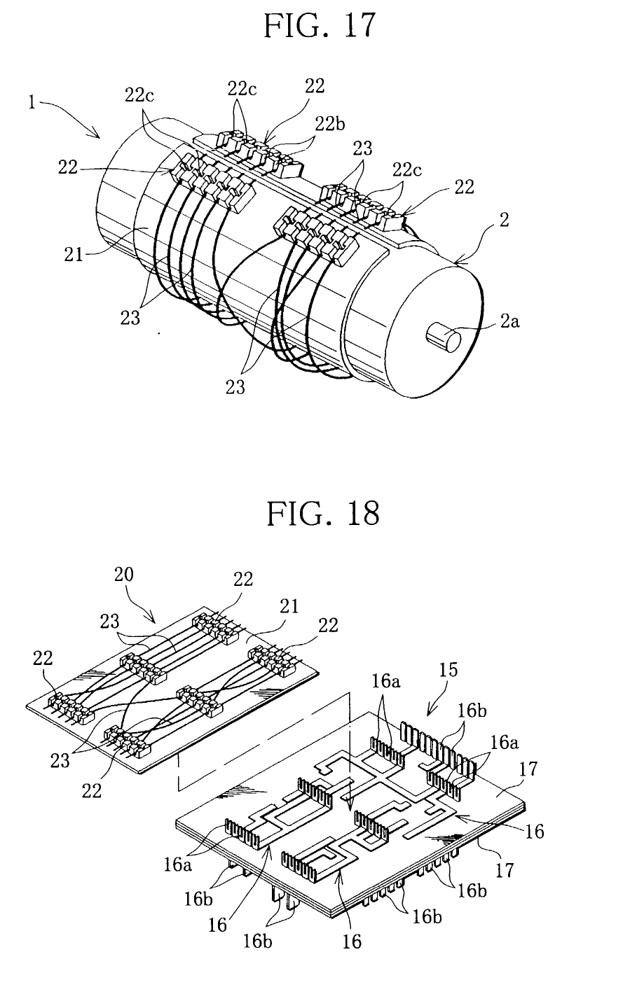

Next, the insulating sheet 21 is put around the wire winding body 2 of the wiring machine 1 to be secured there as shown in FIG. 16. Then, after an electric wire 23 is wired into a desired pattern in the same manner as has been discussed earlier, the electric wire 23 is cut at a desired position, e.g., near the gap between both ends of the insulating sheet 21 as shown in FIG. 17 and is removed from the wire winding body 2, thus yielding a wiring member 20.

Apparently, this embodiment can also manufacture the wiring member 20 in a short period of time by using the wiring machine 1 having a simple structure, without requiring any special wiring plate, and can be easily adapted to a change in circuit design.

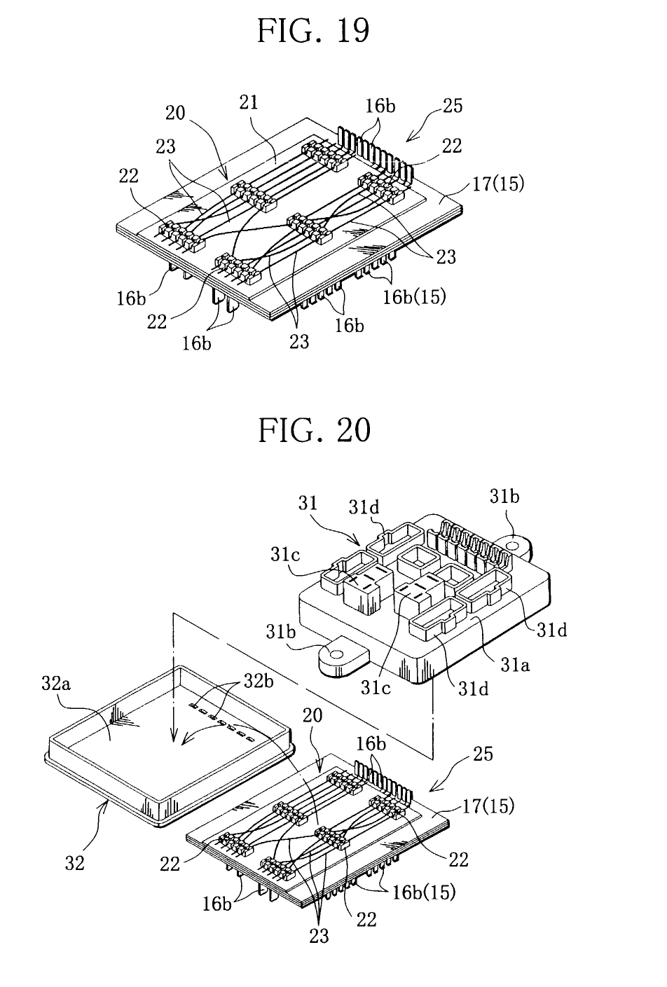

The wiring member 20 manufactured this way is attached to the bus-bar wiring member 15 which has a plurality of bus bars 16 and insulating plates 17 stacked together, as shown in FIG. 18. As a result, the individual pressure-contacting terminals 16a of the bus bars 16 are fitted into the respective terminal grooves 22c of the wire holding members 22, causing the associated bus bars 16 to be connected together by the electric wires 23, so that the wiring member 20 becomes a wiring board 25 as shown in FIG. 19.

Placing the thus manufactured wiring board 25 into an upper case 31 and a lower case 32 as shown in FIG. 20 can provide an electric connection box 30 which is simple and inexpensive and is easily adaptable to a change in circuit design.

The upper case 31 has attachment brackets 31b formed on both sides of a body 31a, mount sections 31c where various kinds of electric parts are mounted, and a connector housing 31d where a connector is attached.

The lower case 32, when fitted into the upper case 31, forms a box, and has a plurality of inserting holes 32b formed in a body 32a where the tab terminals 16b are to be inserted. As illustrated, the wiring board 25 is accommodated, turned over, in the lower case 32.

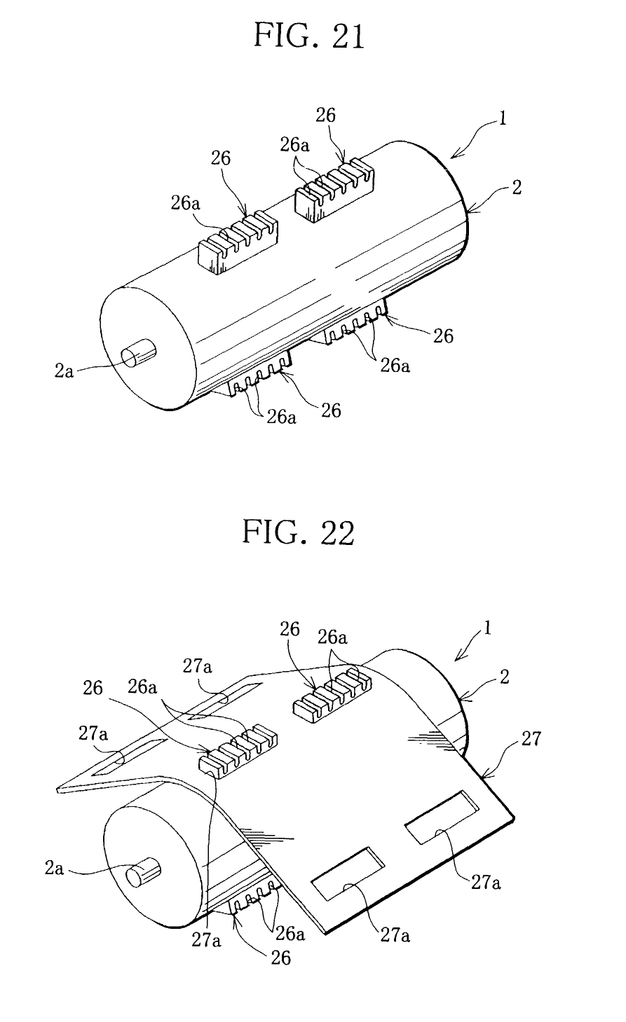

Unlike the wiring member of the above-described embodiment, the wiring member that is designed to improve the working efficiency at the time of removing the wiring member from the wiring machine 1 and in consideration of preventing a contact between the bus bar and the electric wire may be manufactured in such a way that with a plurality of wire holding members 26 attached to the wire winding body 2 of the wiring machine 1 in advance as shown in FIG. 21, an insulating sheet 27 is put around the wire winding body 2 to be secured there.

As illustrated, each wire holding member 26 has a plurality of retaining grooves 22b (sic) formed in a body 26a (sic) widthwise. The insulating sheet 27 has openings 27a (see FIG. 22) formed at positions corresponding to the individual wire holding members 26.

In manufacturing a wiring member, first, the insulating sheet 27 is put around the wire winding body 2 to which the wire holding members 26 have been attached, as shown in FIG. 22. At this time, the individual wire holding members 26 protrude above the insulating sheet 27 through the openings 27a.

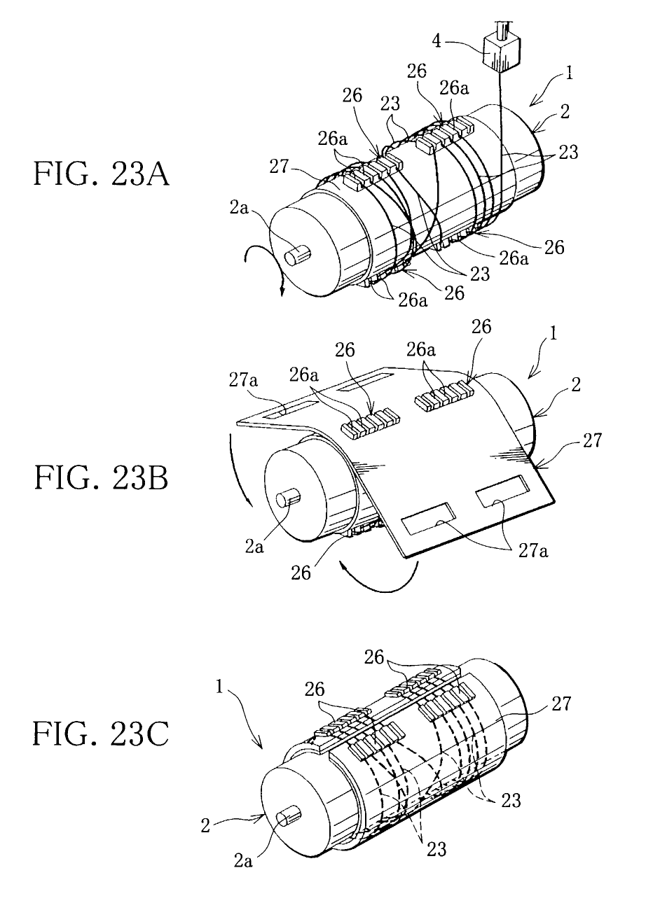

Then, the electric wire 23 is fed out from the wiring head 4 while rotating the wire winding body 2 in the direction of the arrow as shown in FIG. 23A. Accordingly, the wiring machine 1 winds the electric wire 23, fed out from the wiring head 4, around the insulating sheet 27 in a one-stroke drawing fashion and wires the electric wire 23 into a desired pattern by using the retaining grooves 26a of each wire holding member 26 while moving the wiring head 4 in the axial direction of the rotary shaft 2a.

When wiring the electric wire 23 into a desired pattern is completed, the insulating sheet 27 is further put over the electric wire 23 as shown in FIG. 23B.

Then, the electric wire 23 is cut at a desired position, e.g., near the gap between both ends of the insulating sheet 27 as shown in FIG. 23C.

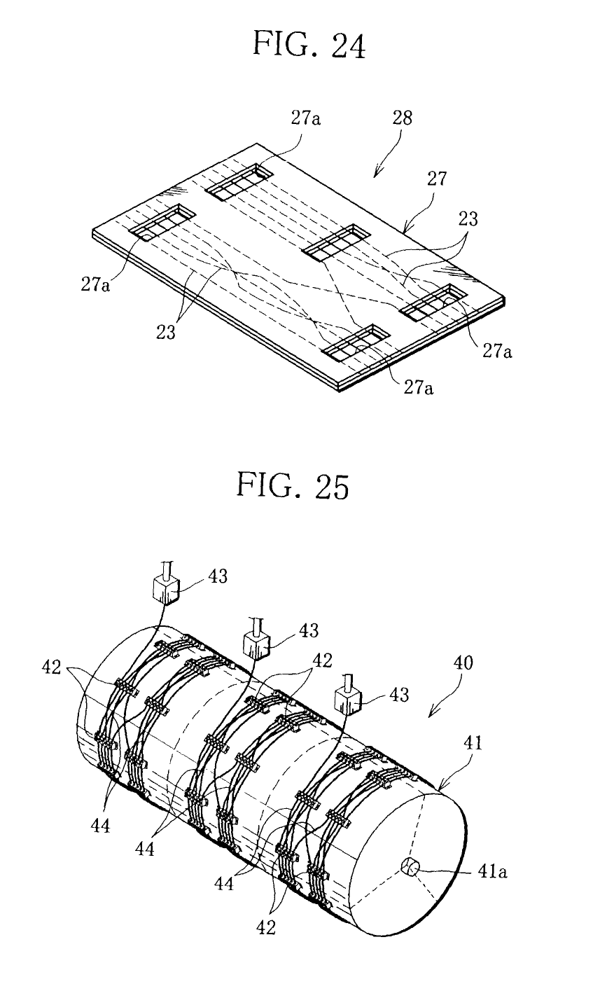

Then, the electric wire 23 is removed together with the insulating sheets 27 from the wire winding body 2 and the wire holding members 26, thus yielding a wiring member 28 shown in FIG. 24 which has the electric wire 23 wired into the desired pattern. This wiring-member manufacturing method of this embodiment therefore facilitates the removal of the wiring member from the wiring machine 1, thus resulting in an improved working efficiency and preventing a contact between the bus bar and the electric wire.

The wiring member 28 manufactured this way is attached to an unillustrated bus-bar wiring member in the same way as has been discussed above, and the associated bus bars are connected together by the electric wires 23, thus yielding a wiring board. As this wiring board is placed in a case, an electric connection box is completed.

To ensure manufacture of a plurality of wiring members simultaneously, the wiring machine to which the wiring-member manufacturing method of this invention is adapted may be modified like a wiring machine 40 shown in FIG. 25. A wire winding body 41 having a rotary shaft 41a has a larger diameter or is made longer so that multiple wire holding members 42 can be attached to the wire winding body 41 and a plurality of wiring heads 43 are provided in association with the wire holding members 42 to wire electric wires 44 in desired patterns. The wire winding body 41 may be comprised of a plurality of separate components which can be assembled closer to or apart from one another in the radial direction so that the diameter of the wire winding body 41 can be altered as needed.

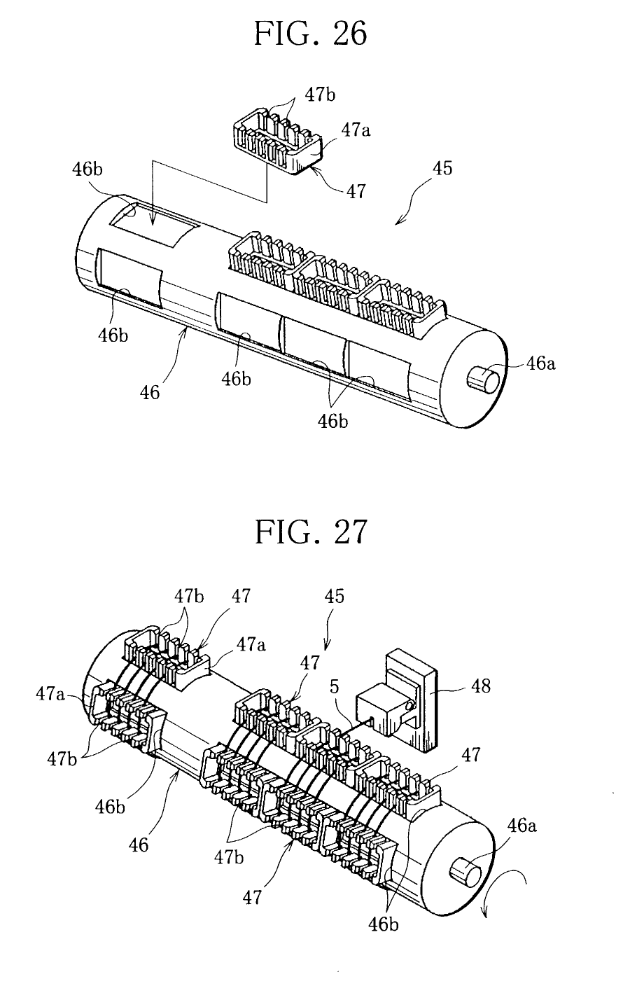

The wiring member may be manufactured by using a wiring machine 45 embodying this invention which will be discussed below. As shown in FIGS. 26 and 27, the wiring machine 45 has a wire winding body 46, a wiring head 48 and a pressing head 54, all of which will be discussed later. The rotation of the wire winding body 46, and the operations of the wiring head 48, the pressing head 54 and so forth are controlled by unillustrated control means.

The wire winding body 46 has a rotary shaft 46a and a plurality of inserting section 46b formed therein for insertion of wire holding members 47. The wire winding body 46 is rotated about the rotary shaft 46a in the direction of the arrow in FIG. 27 by unillustrated drive means. It is to be noted that the wire winding body 46 can rotate in the reverse direction at a desired position to wire the electric wire 5 in a U form depending on the circuit pattern.

First, as shown in FIG. 26, the wire holding members 47 are inserted in the respective inserting sections 46b of the wire winding body 46. Each wire holding member 47 has a plurality of retaining grooves 47b formed in a body 47a and an opening 47c formed in the bottom surface.

Next, the electric wire 5 is fed out from the wiring head 48 while rotating the wire winding body 46 in the direction of the arrow as shown in FIG. 27. Accordingly, the wiring machine 45 winds the electric wire 5, fed out from the wiring head 48, around the wire winding body 46 in a one-stroke drawing fashion and wires the electric wire 5 into a desired pattern by retaining the electric wire by using the retaining grooves 47b of each wire holding member 47 while moving the wiring head 48 in the axial direction of the rotary shaft 46a of the wire winding body 46.

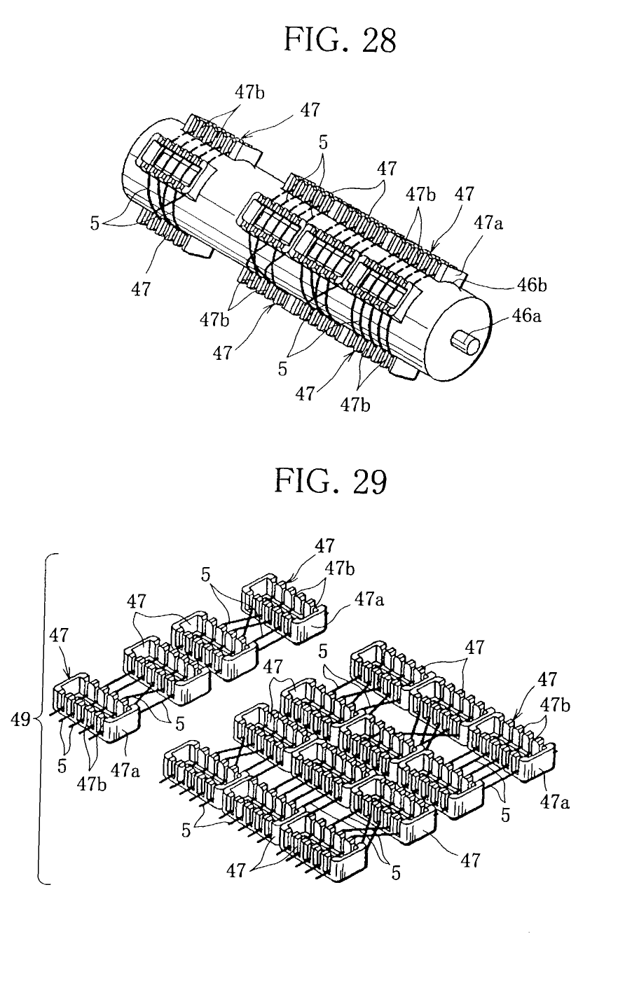

When wiring the electric wire 5 into a desired pattern by winding the electric wire 5 around the wire winding body 46 is completed, the electric wire 5 is cut at a proper position in the vicinity of the wire holding members 47 as shown in FIG. 28.

Then, removing the electric wire 5 together with the wire holding members 47 from the wire winding body 46 yields a precursor 49 of a wiring member which has the electric wire 5 wired into a desired pattern, as shown in FIG. 29.

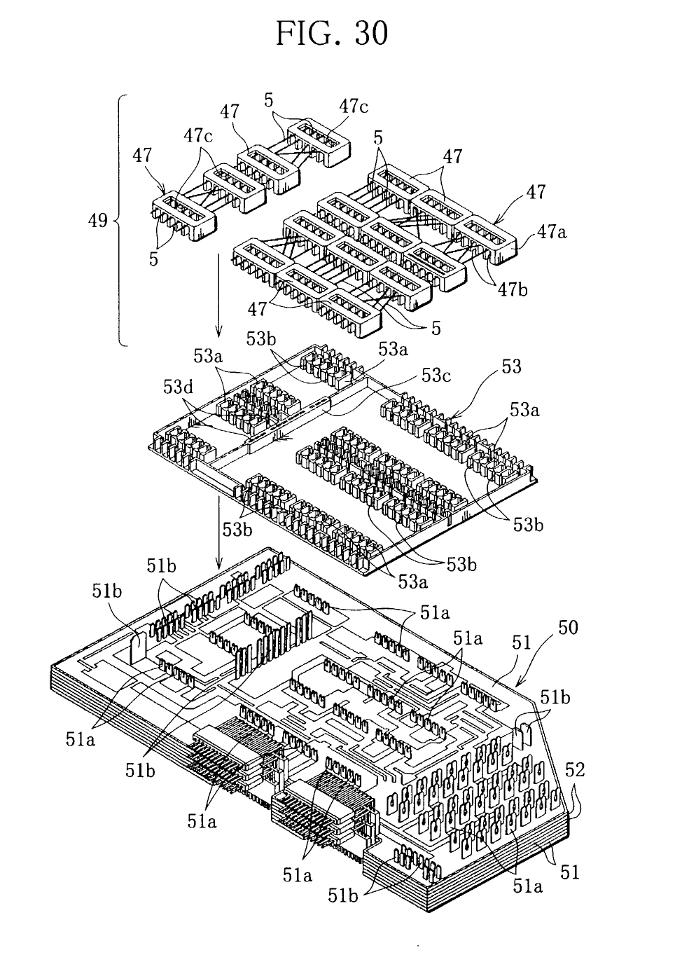

Then, the precursor 49 is turned over from the state shown in FIG. 29 and is attached to a bus-bar wiring member 50 via an insulating spacer 53 as shown in FIG. 30.

The bus-bar wiring member 50, like the bus-bar wiring member 15, has a plurality of bus bars 51 and insulating plates 52 alternately stacked. The bus bar 51 has a plurality of pressure-contacting terminals 51a and tab terminals 51b protruding at proper locations. The insulating plate 52 has inserting holes (not shown) at positions corresponding to the pressure-contacting terminals 51a and tab terminals 51b, so that the pressure-contacting terminals 51a and tab terminals 51b, inserted through the inserting holes, protrude from the top and bottom surfaces of the bus-bar wiring member 50. As illustrated, the insulating spacer 53 has a plurality of inserting sections 53a formed in a rectangular cylindrical shape and a rib-like inserting section 53c provided on the plate surface. The pressure-contacting terminals 51a are to be inserted into the respective inserting section 53a. Each inserting section 53a has a holding groove 53b formed therein, and the inserting section 53c has a plurality of inserting holes 53d formed therein where the tab terminals 51b are to be inserted.

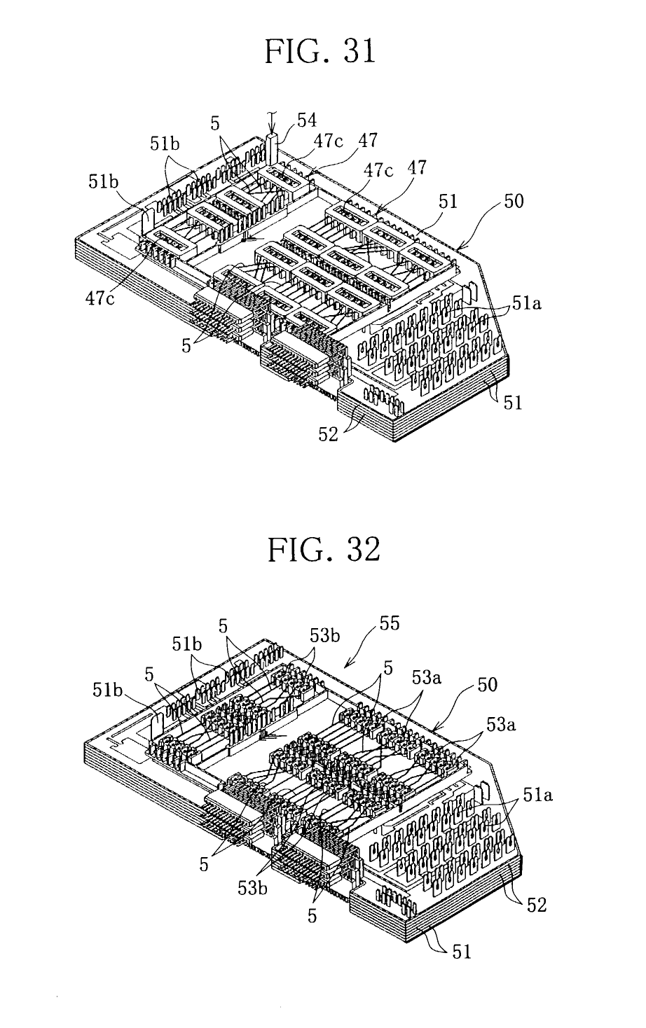

The precursor 49 of the wiring member is attached to the bus-bar wiring member 50 via the insulating spacer 53 as shown in FIG. 31. Under this situation, as illustrated, the pressing head 54 is moved down from above to press the electric wire 5 held in the retaining grooves 47b of each wire holding member 47 through the opening 47c. As a result, the pressing head 54 separates the electric wire 5 from the wire holding member 47 and holds the electric wire 5 into the holding groove 53b of the associated inserting section 53c (sic).

After the electric wires 5 are moved to the holding grooves 53b of the insulating spacer 53 from all the wire holding members 47, only the wire holding members 47 are removed from the bus-bar wiring member 50, yielding a wiring member 55 as shown in FIG. 32.

As the wiring member 55 is manufactured by using the wiring machine 45 having a simple structure embodying this invention, the wiring member 55 can be produced in a short period of time without requiring any special wiring plate, and can be easily adapted to a change in circuit design.

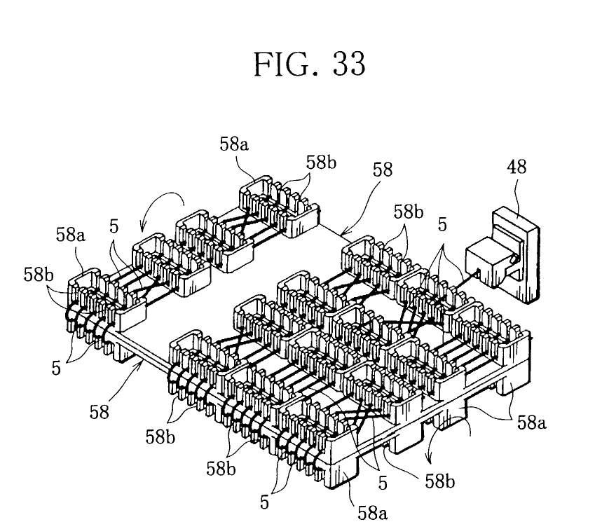

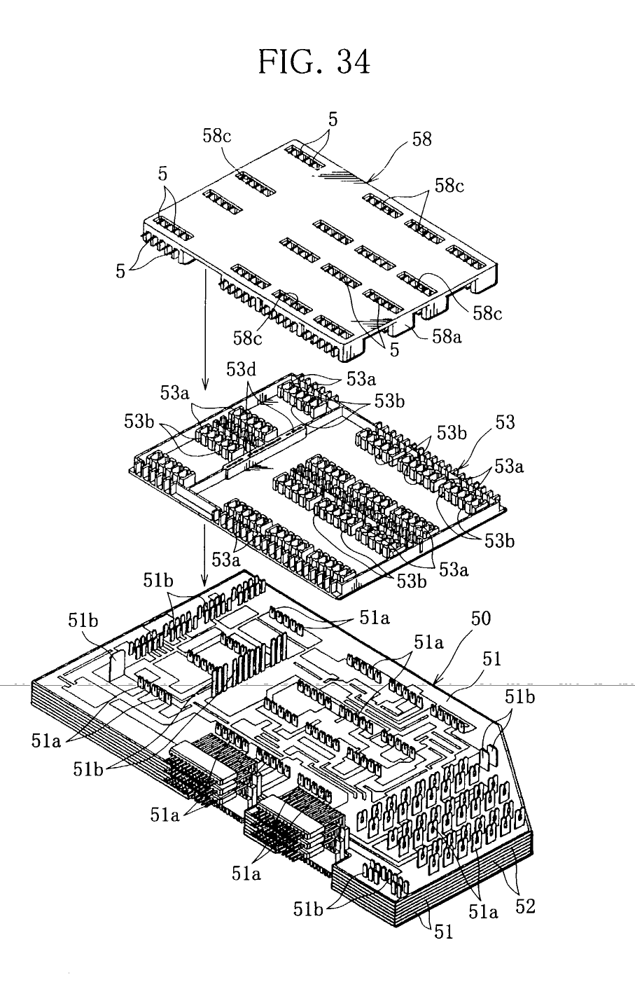

As shown in FIG. 33, a wiring member may be manufactured by using two wire holding plates 58 put together, each having a plurality of wire holding sections 58a each of which has the same structure as the wire holding member 47 shown in FIG. 30 and has a plurality of retaining grooves 58b formed in each wire holding section 58a for retaining the electric wire 5 and an opening 58c (see FIG. 34) formed in the bottom surface.

While the two wire holding plates 58 put together is rotated in the direction of the arrow, the wiring head 48 is moved to wire the electric wire 5 into a desired pattern as shown in FIG. 33. When wiring the electric wire 5 is completed, the electric wire 5 is cut at the edge portions of the wire holding plates 58 or at proper positions, so that the two wire holding plates 58 are separated from each other. This method can allow two wire holding plates 58 to be wired with the electric wire in a single wiring work, thus shortening the overall time needed to manufacture a wiring member.

Thereafter, each wire holding plate 58 is turned over and is attached to the bus-bar wiring member 50 via the insulating spacer 53 in the same way as discussed previously. Then, the electric wire 5 is removed from each wire holding section 58a and is held into the holding groove 53b of the associated inserting section 53c by using the pressing head 54 thereby separating the wire holding plate 58 from the bus-bar wiring member 50. This method can manufacture the wiring member 55 shown in FIG. 32 faster.

According to the wiring-member manufacturing method of this invention, wiring may be accomplished by fixing the wire winding body 2, 41 or 46, or the wire holding plates 58 and moving the wiring machine and thus the electric wire side to wind the electric wire around the wire winding body 2, 41 or 46, or the wire holding plates 58.

What is claimed is:

1. A method of manufacturing a wiring member comprising the steps of:
winding an electric wire around a wire winding body having a plurality of wire holding members arranged thereon, and wiring said electric wire into a desired pattern using a plurality of retaining sections formed on each of said wire holding members;
cutting said electric wire at a desired position; and
removing said electric wire at least from said wire winding body.

2. The method according to claim 1, wherein a rotary shaft and a plurality of inserting sections where said wire holding members are inserted are formed on said wire winding body.

3. The method according to claim 1, wherein said retaining sections are retaining grooves.

4. The method according to claim 2, wherein said retaining sections are retaining grooves.

5. The method according to claim 3, wherein each of said wire holding members has a terminal groove formed in a direction perpendicular to a layout direction of said plurality of retaining grooves.

6. The method according to claim 4, wherein each of said wire holding members has a terminal groove formed in a direction perpendicular to a layout direction of said plurality of retaining grooves.

7. An electric connection box manufactured by retaining a wiring member manufactured by the method as set forth in claim 1 in a case.

8. The electric connection box according to claim 7, wherein said case has an upper case and a lower case.
